(19) United States
(12) Patent Application Publication
(10) Pub. No.: US 2002/0032684 A1
(43) Pub. Date: Mar. 14, 2002

(54) Directory information management apparatus, directory information management method, and computer readable recording medium having directory information management program stored therein

(76) Inventors: Chieko Kobayashi, Kawasaki-shi (JP); Shuji Harashima, Fuchu-shi (JP); Asahiko Yamada, Tokorozawa-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 09/906,732

(22) Filed: Jul. 18, 2001

(30) Foreign Application Priority Data
Jul. 18, 2000 (JP) 2000-217529

(51) Int. Cl. G06F 7/00

(52) U.S. Cl. 707/100

(57) ABSTRACT

A directory information management apparatus using a tree structured database wherein entries are registered in a tree shape, the entry comprising at least one attribute, the directory information management apparatus comprises a schema database which stores object classes for entry types, the object class comprising at least one attribute, a template generating section which, when a new entry type is created from object classes, reads object classes in accordance with an entry type from the schema database, combines duplicate attributes belonging to the object classes, and generates template information indicating attributes included in the entry, and a template database which stores the generated template.

### CROSS-REFERENCE TO RELATED APPLICATIONS

This application is based upon and claims the benefit of priority from the prior Japanese Patent Application No. 2000-217529, filed Jul. 18, 2000, the entire contents of which are incorporated herein by reference.

### BACKGROUND OF THE INVENTION

1. Field of the Invention

The present invention relates to a directory information management apparatus and a directory information management method for managing information provided in a directory service, and a computer readable recording medium having a directory information management program stored therein.

2. Description of the Related Art

Integrated information management is provided as a technique for improving productivity in an information system. A standard interface is desired in order to access integrally managed information, and a directory server is utilized in order to achieve this object.

The directory server is produced, and an information management service utilizing this directory server is called a directory service.

In the directory service, a set of information called entry is registered in a database configured in a tree shape called a directory information tree. An entry such as “person” or “organization” has an attribute such as name, organization name, telephone number, or address.

A user utilizing such directory service defines as a key an easily understandable attribute such as name or organization name for an entry, and receives a client/server type service for reading and writing an attribute such as a telephone number or address included in this entry.

FIG. 1 is a view showing a specific configuration example of a directory information tree.

An entry “person” or an entry “organization” configuring this directory information tree stores individual information such as “company name (o)”, “organization name (ou)”, “name (cn)”, or “telephone number (telephonenumber)” as an attribute. FIG. 1 shows a directory information tree of the ABC company.

A set of attributes is managed and utilized in units called an object class (objectclass). The type of attribute configuring each entry differs depending on entry type, and attribute type differs depending on object class. That is, an object class is designated according to entry type, and the type of attribute configuring each entry differs depending on the designated object class. Thus, the object class is designated based on the entry type, and it is determined what attribute that entry has depending on such designated object class.

A method for utilizing a specific object class will be described here. For example, assume that there are an “in-house information” object class whose attribute is name or address and a “personnel information” object class whose attribute is a personal history. In the case of creating an entry used for general search (such as telephone directory search) in company, the “in-house information” object class is utilized. In the case of creating an entry used for searching for a company's personal department, the “in-house information” object class and the “personnel information” object class are utilized.

In this way, a required attribute differs depending on the object of search or management. Thus, a plurality of object classes are created beforehand, and an entry is created by using these classes, thereby generally making it possible to efficiently manage in-house information or create entries.

In FIG. 1, entry types include “person” and “organization”, for example. Instances of the entry “person” include “taro” and “hanako”, and instances of the entry “organization” includes “system-group”, for example.

In the entry “person”, an attribute “cn” is employed for an identification name “dn”, and in the entry “organization”, an attribute “ou” is employed for an identification name “dn”. If an entry type is “person”, such an entry is formed of object classes “top”, “person”, “organizationalPerson”, and “inetOrgPerson”. If an entry type is “organization”, such an entry is formed of object classes “top” and “organizationalUnit”.

FIG. 2 is a view showing an example of an object class and attribute configured by such an object class. In FIG. 2, only object classes “top”, “person”, and “organizationalPerson” are typically shown from among “top”, “person”, “organizationalPerson”, “inetorgPerson”, and “organizationalUnit”. In a directory, an object class is classified into three: structure type, addition type, and special type. “Top” is a superclass of “person”. “Person” is a superclass of “organizationalPerson”. Structure type is an object class having a structure, is a basic class for creating entries, and comprises a set of attributes determining a characteristic of an entry. “Top-personorganizationalPerson” falls into the structure type. Addition type is an object class that is singly made and a group of attributes having similar characteristics. The additional type is always used by being added to the structure type object class for creating an entry. Special type is a superclass of another object class, and an entry is made from this class. “Top” falls into the is special type.

For example, an object class “person” includes attributes “sn”, “cn”, “description”, “seeAlso”, “telephoneNumber”, and “userPassword”. This is applied to the other case as well.

An object class has a hierarchical structure. For example, the object class “person” has an object class “top” as a parent. The object class “organizationalperson” has the object class “person” as a parent. In each attribute, an attribute described as “requires” is a mandatory attribute which is always included in an entry. On the other hand, an attribute described as “allows” is an optional attribute which may be or may not be included in an entry.

FIG. 3 is a view illustrating the contents of an attribute. In FIG. 3, only attributes belonging to object classes “top”, “person”, and “organizationalPerson” are typically shown from among attributes belonging to the above object classes “top”, “person”, “organizationalPerson”, “inetOrgPerson”, and “organizationalUnit”.

A management number (oid) is assigned to each attribute, and data type is defined. Some attributes are assigned with other names.

Data types include the following.

(1) bin: Binary

(2) ces: Character string that discriminates uppercase and lowercase letters (Case Exact String)

(3) cis: Character string that does not discriminate uppercase and lowercase letters (Case Ignore String)

(4) tel: Telephone number (Blanks and dashes are ignored at the time of comparison, as in “cis”.)

(5) dn: Identification name (Distinguished Name)

(6) int: Integer

(7) Operaional: Reserved word (operational attribute is not displayed for search result.)

(8) single: Only one

Note that types (7) and (8) are additional information of types (1) to (6), which are not unique types.

A directory service includes wide service coverage. Apart from a utilization method such as a mere telephone directory search, a user ID/password (or public key certification) is managed as authentication information, thereby making it possible to utilize this service in order to achieve “signal sign on”. Further, apart from integrated information management, it is possible to exchange information with other applications or to share information. One of the protocols for accessing a directory server includes an LDAP (Lightweight Directory Access Protocol). This LDAP is a standard protocol used over Internet, and can be easily accessed over TCP/IP.

In a general directory server, directory information is added, modified, and deleted by employing the following four methods, and the information is managed:

(1) A method of importing/exporting information into/from a directory database of a directory server by using a file in accordance with an LDIF (LDAP Data Interchange Format) format;

(2) A method utilizing a command prepared for accessing the directory database by the directory server;

(3) A method utilizing a maintenance tool (GUI) provided in the directory server; and

(4) A programming method using an LDAP-API (library) provided in the directory server.

Of the above methods, the method (1) is utilized if a large amount of data (entries) is batch registered, modified, and deleted, is moved from another database, or is partially modified.

The method (2) is utilized in the case of simply operating a small amount of data (entries) from a command line;

The method (3) is utilized in the case of interactively executing an operation by utilizing a GUI provided as accessories of the directory server product.

The method (4) is utilized in the case of constructing an application by using the directory access protocol LDAP-API.

However, in the case of operating directory information by using the methods (1) to (4), the following problems occur.

Although the method (1) is a simple method in that a text file is utilized in accordance with a predetermined format, it is required to describe all entry information such as entry identification name “dn” (entry storage place), object class, attribute, or type, which is cumbersome.

Although the method (2) is convenient in the case of operating a small amount of entry information, it is not practical because it is executed from a command line.

Although the method (3) is provided in each product of the directory server, only a function for operating a required minimum of directory information is provided, which is not practical.

Although the method (4) is an API for accessing a directory server in the case of generating such a tool or an application as substituted for the method (3), such an API is not readily utilized because it must be generated in advance. There is a problem that the usability depends on the use of a constructed tool or application.

In any of the methods (1) to (4) as well, an entry must be generated considering directory schema information, i.e., entry identification name “dn”, an object class name configuring entry, an attribute name belonging to that object class, whether that attribute is mandatory or arbitrary, and attribute data type. Failure to consider schema information causes an unmatched attribute to occur in entry.

FIG. 4 is a view illustrating a specific example of a problem that occurs if directory schema information is not considered.

For example, an object class 1A includes an attribute “name” described as “requires” and attributes “address”, “telephone number”, and “E-mail” described as “allows”. The other object class 1B includes attributes “name” and “address” described as “requires” and attributes “telephone number” and “FAX number” described as “allows”. A new entry 2 is formed based on the object class 1A and object class 1B.

The entry 2 has attributes “name”, “name”, and “address” described as “requires” and attributes “address”, “telephone number”, “E-mail”, “telephone number”, and “FAX number” described as “allows”. Entry 2 has an attribute “address” described as “requires” and an attribute “address” described as “allows”, wherein coincidence of whether or not the attribute “address” is mandatory or arbitrary is not obtained. In addition, entry 2 has a plurality of attributes “name”, “address”, and “telephone number”. In a directory, entry 2 is a set of attributes, and it cannot be determined which object class an information searched attribute belongs to. Thus, when a search is executed, an intended “name”, “address”, or “telephone number” may not be acquired.

In this way, if attributes of the same names exist, for example, although a technique for managing duplicate attribute “telephone numbers” as “telephone number 1” and “telephone number 2” is utilized, one must know how many attributes of the same names exist. For example, if an address is registered in this entry 2, it is difficult to grasp which attribute such address is registered in.

If an information search is made for such an entry in which there is no coincidence in attributes, a search may not be normally executed.

In addition to the foregoing problem, if an attribute of an entry is formed of a plurality of object classes, if such attribute is deleted in managing directory information, an attribute of its required object class may be erroneously deleted.

FIG. 5 is a view illustrating a case in which an attribute of its required object class is deleted.

For example, assume that one object class 1C has attributes “name” and “telephone number” described as “requires”, and the other object class 1D has attributes “name” and “address” described as “requires”.

In entry 3 in which an attribute is formed of object class 1C and object class 1D, assuming that an identification name (dn) is “name”, such identification name must be unique, and thus, a plurality of names cannot be assigned. Therefore, entry 3 has attributes “name”, “address”, and “telephone number” described as “requires”.

Consider a case in which, when entry 3 is managed, information defined in the object class IC is unnecessary at a certain time, and one object class 1C is deleted from this entry 3.

In this case, when attributes “name” and “telephone number” are deleted from entry 3 by utilizing a definition of the object class 1C, an attribute “telephone number” in the object class 1C is deleted from entry 3, and “name” is deleted as well. However, this “name” is required in the other object class 1D.

Thus, in an entry formed of a plurality of object classes, an attribute belonging to an object class targeted to be deleted may belong to an object class that is not targeted to be deleted.

Therefore, if an attribute of entry is deleted together with deletion of an object class, necessary information may be deleted as well.

An entry managed in a directory is set mainly as an object class. However, in the case of utilizing this entry, it is impossible to identify what is an object class of an entry owned attribute. Therefore, unless an attribute coincidence is ensured, there is a problem that an inconvenience occurs in entry management.

### BRIEF SUMMARY OF THE INVENTION

The present invention has been made in order to solve the foregoing problem. It is an object of the present invention to provide a directory information management apparatus, a directory information management method, and a computer readable recording medium having a program recorded therein, capable of properly handling an entry which is formed of attributes of a plurality of object classes.

According to one aspect of the present invention, a directory information management apparatus using a tree structured database wherein entries are registered in a tree shape, the entry comprising at least one attribute, the directory information management apparatus comprises:

a schema database which stores object classes for entry types, the object class comprising at least one attribute;

a difference generating section which generates difference information of attribute that belongs to two object classes stored in the schema database; and

a difference database which stores the difference information generated by the difference generating section.

According to another aspect of the present invention, a directory information management apparatus using a tree structured database wherein entries are registered in a tree shape, the entry comprising at least one attribute, the directory information management apparatus comprises:

a schema database which stores object classes for entry types, the object class comprising at least one attribute;

a template generating section which, when a new entry type is created from object classes, reads object classes in accordance with an entry type from the schema database, combines duplicate attributes belonging to the object classes, and generates template information indicating attributes included in the entry;

a difference generating section which generates difference information of attribute that belongs to two object classes stored in the schema database; and

a difference database which stores the difference information generated by the difference generating section.

According to the present invention, it is possible to properly handle an entry which is formed of attributes of a plurality of object classes.

### BRIEF DESCRIPTION OF THE SEVERAL VIEWS OF THE DRAWING

The accompanying drawings, which are incorporated in and constitute a part of the specification, illustrate embodiments of the present invention and, together with the general description given above and the detailed description of the embodiments given below, serve to explain the principles of the present invention in which:

FIG. 1 is a view showing a specific configuration example of a directory information tree;

FIG. 2 is a view showing an example of an object class and an attribute included in the object class;

FIG. 3 is a view illustrating the contents of an attribute;

FIG. 4 is a specific example of a problem that occurs if directory schema information is not considered;

FIG. 5 is a view illustrating a case in which an attribute of its required object class is deleted;

FIG. 6 is a block diagram illustrating a detailed configuration of a directory information management apparatus according to a first embodiment of the present invention;

FIG. 7 is a view showing a configuration of four user types and the corresponding object class types;

FIG. 8A to FIG. 8E are views each illustrating a duplicate relationship between attributes each belonging to four user types;

FIG. 9 is a block diagram illustrating an outline of generating template information and difference information in the directory information management apparatus according to the first embodiment;

FIG. 10 is a flow chart illustrating processing executed by the directory information management apparatus according to the first embodiment;

FIG. 11 is a flow chart illustrating the details on processing executed by an entry type discriminating section of the directory information management apparatus according to the first embodiment;

FIG. 12 is a flow chart showing the details on processing executed by a schema acquiring section of the directory information management apparatus according to the first embodiment;

FIG. 13 is a flow chart showing the details of processing executed by a template generating section of the directory management apparatus according to the first embodiment;

FIG. 14 is a flow chart showing the details of processing executed by a difference calculating section of the directory information management apparatus according to the first embodiment;

FIG. 15 is a view illustrating an attribute operation state of an entry caused by the directory information management apparatus according to the first embodiment; and

FIG. 16 is a block diagram illustrating a schematic configuration of a directory information management apparatus according to a second embodiment of the present invention.

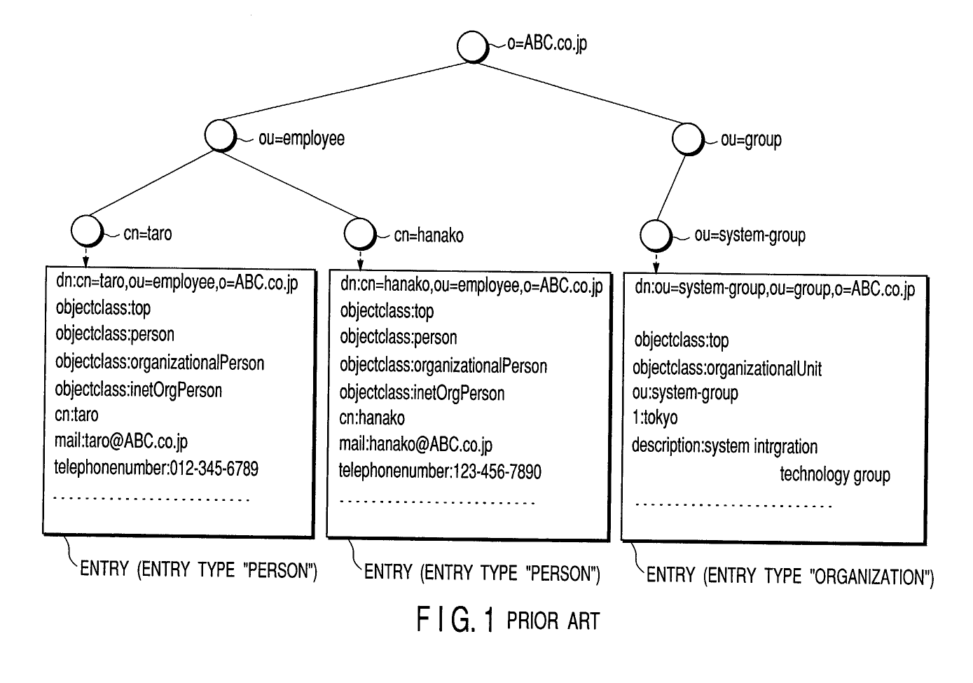

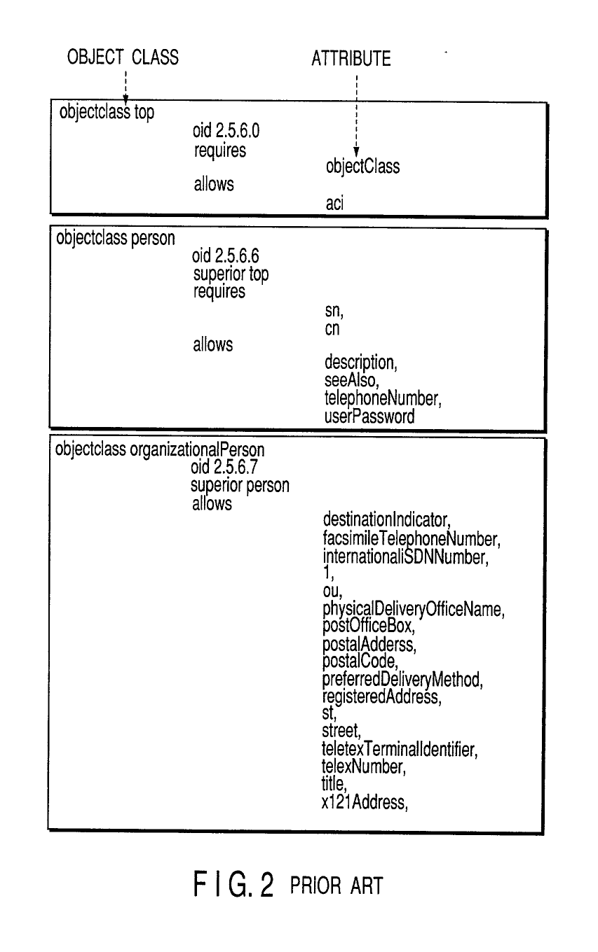

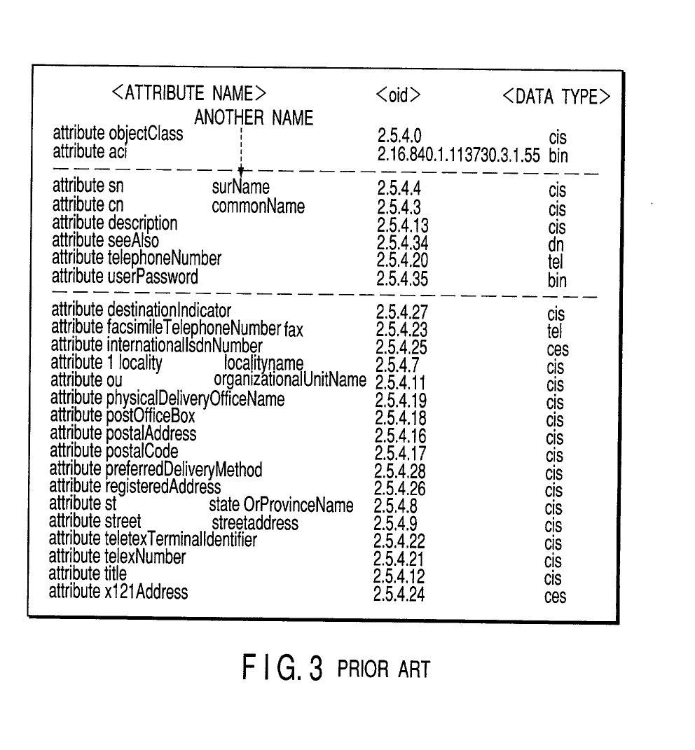

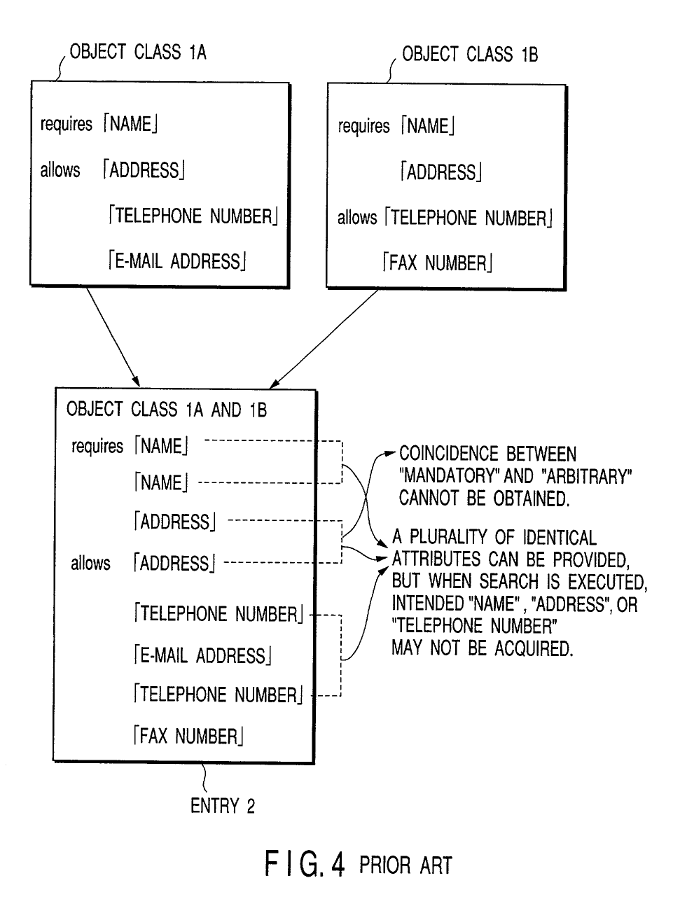

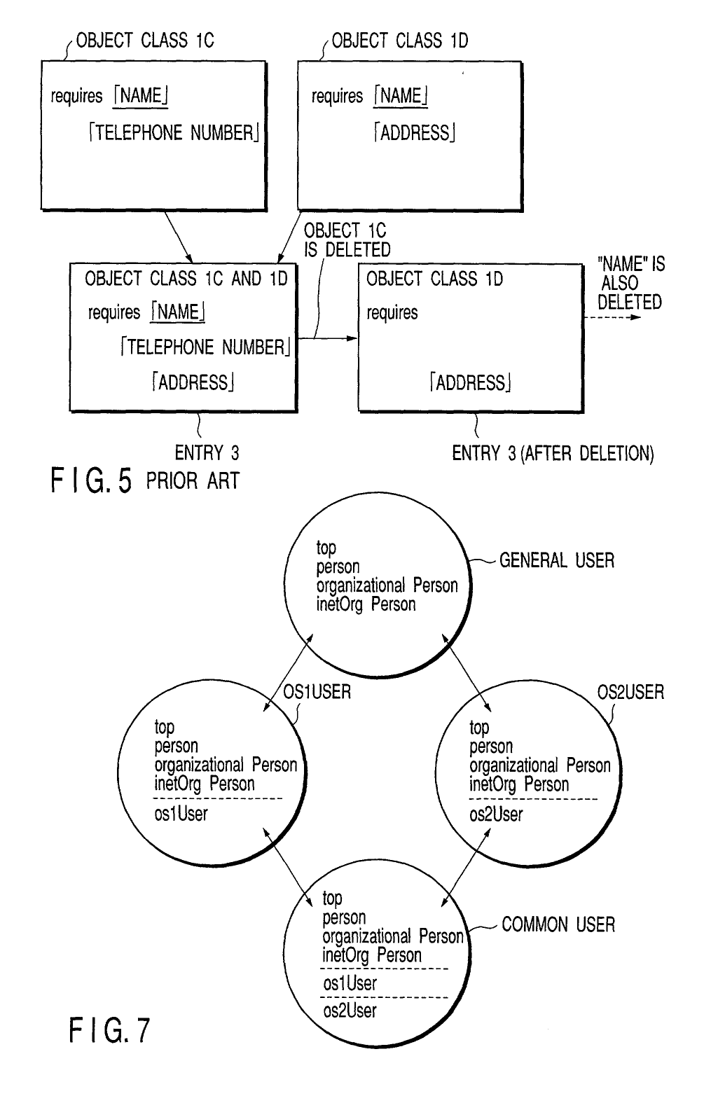

### DETAILED DESCRIPTION OF THE INVENTION

An embodiment of a directory information management apparatus according to the present invention will now be described with reference to the accompanying drawings.

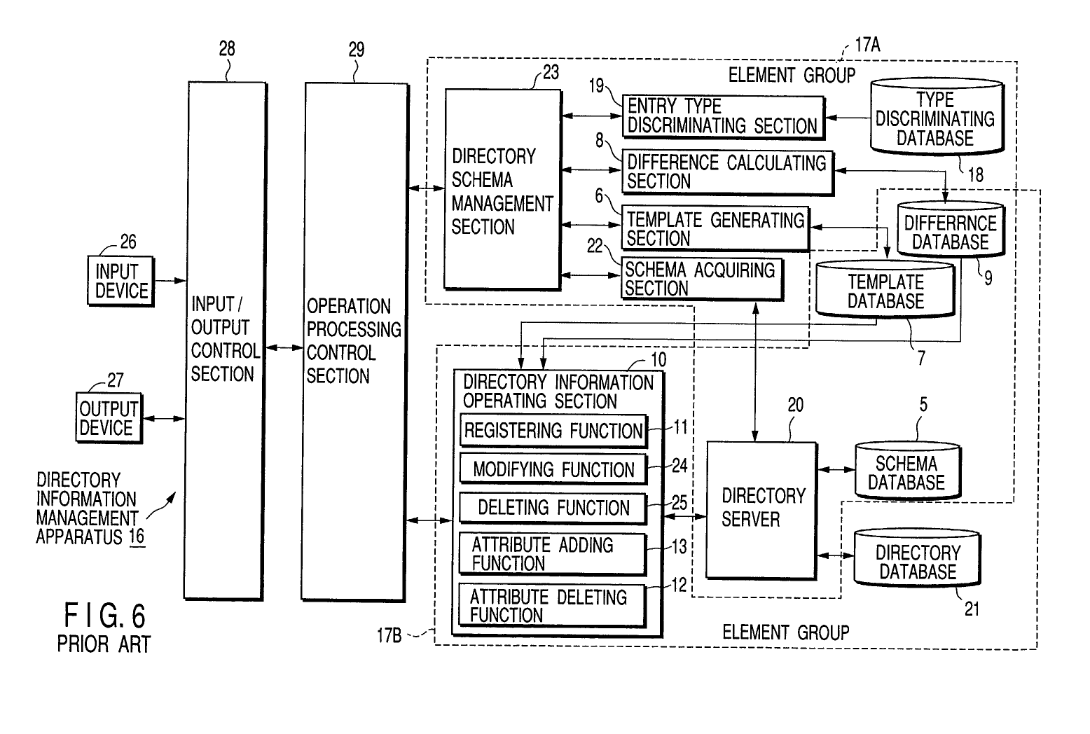

FIG. 6 is a block diagram illustrating a schematic configuration of a directory information management apparatus according to the present embodiment.

A directory information management apparatus 16 according to the present embodiment comprises an element group 17A that is a set of constituent elements concerning generation of template information and difference information, an element group 17B that is a set of constituent elements concerning control of an object class and an attribute (some elements are a duplicate of the element group 17A), and an input device 26, output device 27, input/output control section 28, and operation processing control section 29 common to both of these element groups 17A and 17B.

In the element group 17A, a schema database 5 referred to by a directory server 20 stores schema information that is information concerning an attribute for each object class.

A template generating section 6 generates template information for generating an entry free of an attribute duplication for an entry type based on the entry class and object class acquired by an entry type discriminating section 19 and the schema information acquired by a schema acquiring section 22 and stores the template information in a template database 7. Therefore, the template database 7 stores template information indicative of a set of attributes free of duplication for configuring an entry based on the object class, attribute, and attribute type in entry type.

A difference calculating section 8 obtains a difference in attributes between entry types based on the entry type and object class discriminated by an entry type discriminating section 19 and the schema information acquired by a schema acquiring section 22, and stores the difference information in a difference database 9. Therefore, the difference database 9 stores attribute difference information among entry types.

A type discriminating database 18 is a database that stores information for discriminating entry type and acquiring an object class that belongs to that entry type.

An entry type discriminating section 19 discriminates entry type by referring to the type discriminating database 18, and acquires an object class that belongs to this entry type.

The directory server 20 manages directory information (entry information). The schema information (directory schema) is defined in the schema database 5, and directory information is stored in a directory database 21.

A schema acquiring section 22 is defined by the directory server 20, and schema information being managed is acquired.

A directory schema management section 23 controls the entry type discriminating section 19, schema acquiring section 22, template generating section 6, and difference calculating section 8, and manages a directory schema.

In the element group 17B, a directory information operating section 10 accesses the directory server 20 and operates directory information. This operating section 10 essentially comprises a registering function 11, attribute deleting function 12, attribute adding function 13, modifying function 24, and deleting function 25.

During entry registration, the registering function 11 refers to the template database 7 to generate an entry that includes information on an attribute indicated by the corresponding template information, and registers the entry in the directory server 20 (directory database 21).

If an attribute defined in an object class is deleted from an entry, the attribute deleting function 12 refers to difference information included in the difference database 9 to register in the directory server 20 (directory database 21) an entry having deleted therefrom information on an attribute that is included before deletion, but is not included after deletion.

If an attribute defined in an object class is added to an entry, the attribute adding function 13 refers to difference information included in the difference database 9 to register in the directory server 20 (directory database 21) an entry having added thereto information on an attribute that is not included before addition, but is included after addition.

The directory information operating section 10 executes the modifying function 24 for changing the contents of an entry that corresponds to entry type and a deleting function 25 for deleting an entry that corresponds to the entry type.

The input device 26 that is not included in any of the element groups 17A and 17B inputs information managed in a directory or information required for managing information in a directory such as entry type. The output device 27 outputs a response to an input from the input device 26. The input/output control section 28 controls information handled by the input device 26 or output device 27.

An operation processing control section 29 operates information handled by the directory schema management section 23 or directory information operating section 10.

The directory information management apparatus 16 will be described in more detail by way of showing an example when user information is managed by this directory information management apparatus 16. In the following description, four user types (general user, OS1 user, OS2 user, and common user) are targeted to be managed as a specific example. That is, these four user types are defined as entry types. These four user types are classified according to type of object class included in an entry.

FIG. 7 is a view showing four user types and type of object class configuring them.

A general user denotes type of user registered in the directory server 20 only. This general user includes a user utilizing personnel management in company/organization or WWW contents. The general user is formed of object classes “top”, “person”, “organizationalPerson”, and “inetOrgPerson”.

An OS1 user denotes the type of user that is registered in the directory server 20, and is generated together with an account for utilizing an operating system (hereinafter, referred to as OS1). That is, in addition to management of this user as a general user, a user requiring an account for utilizing OS1 is defined as OS1 user. The OS1 user is formed of object classes “top”, “person”, “organizationalPerson”, “inetOrgPerson”, and “os1User”.

An OS2 user denotes the type of user that is registered in the directory server 20, and is generated together with an account for utilizing another operating system (hereinafter, referred to as OS2). That is, in addition to management of this user as a general user, a user requiring an account for utilizing OS2 is defined as OS2 user. The OS2 user is formed of object classes “top”, “person”, “organizationalPerson”, “inetOrgPerson”, and “os2User”.

A common user denotes the type of user that is registered in the directory server 20, and is generated together with an account for using both of OS1 and OS2. That is, in addition to management of this user as a general user, a user requiring an account for utilizing OS1 and OS2 is defined as this common user. The common user is formed of object classes “top”, “person”, “organizationalPerson”, “inetOrgPerson”, “os1User”, and “os2User.

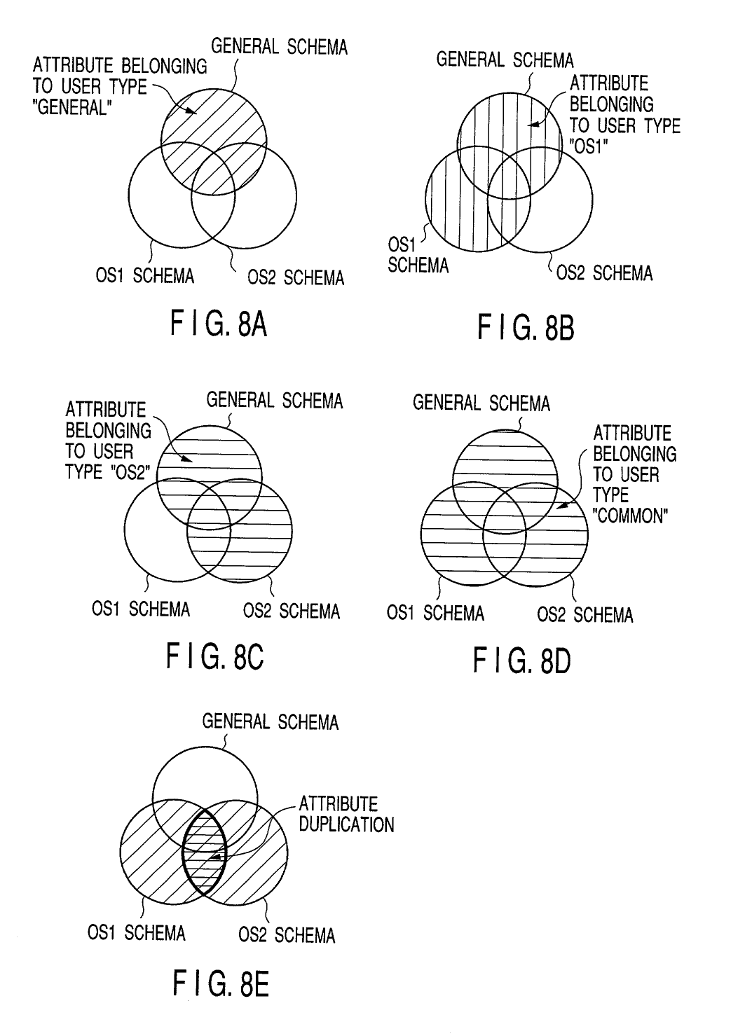

FIGS. 8A to 8E are views each illustrating a duplicate relationship in attributes each belonging to four user types.

FIGS. 8A to 8D are views showing what schema to which attributes belonging to user types “general”, “OS1”, “OS2”, and “common” and each schema belong.

FIG. 8A shows that an attribute belonging to “general” belongs to a general schema. FIG. 8B shows that an attribute belonging to user type “OS1” belongs to a general schema and an OS1 schema. FIG. 8C shows that an attribute belonging to “OS2” belongs to a general schema and an OS2 schema. FIG. 8D shows that an attribute belonging to user type “common” belongs to a general schema, an OS1 schema, and an OS2 schema.

Among them, an attribute duplication occurs at a portion at which a plurality of schemas are duplicated. FIG. 8E illustrates a duplicate portion of attributes.

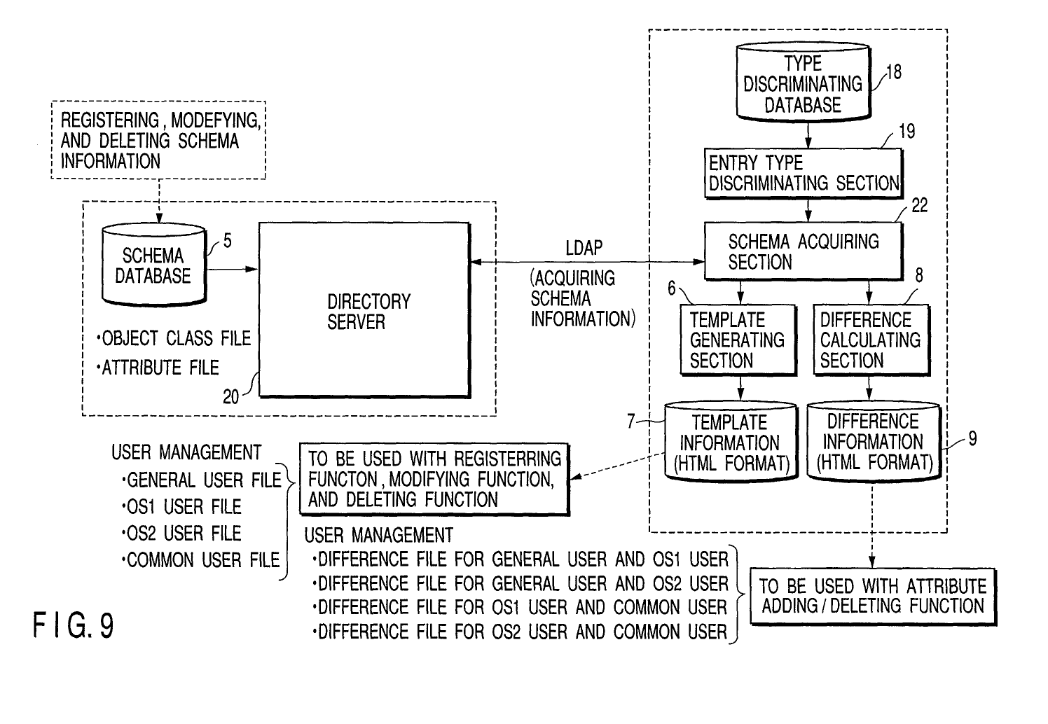

FIG. 9 is a block diagram illustrating an outline when template information and difference information are generated in the directory information management apparatus 16 according to the present embodiment.

The template information and difference information are stored in the databases 7 and 9 in the form of, for example, HTML format. The template information file comprises a general user file, OS1 user file, OS2 user file, and common user file. The difference information file comprises a difference file between the general user file and the OS1 user file, difference file between the general user file and OS2 user file, difference file between the common user file and OS1 user file, and difference file between the common user file and OS2 user file. The directory server 20 configures entry information based on schema definition information files (an object class file and an attribute file) included in the schema database 5.

Here, schema information is not always unmodified (fixed). The schema information may be modified according to addition, modification, and deletion of an entry managed in a directory. Entry type, i.e., a set of object classes defining a set of attributes may be modified.

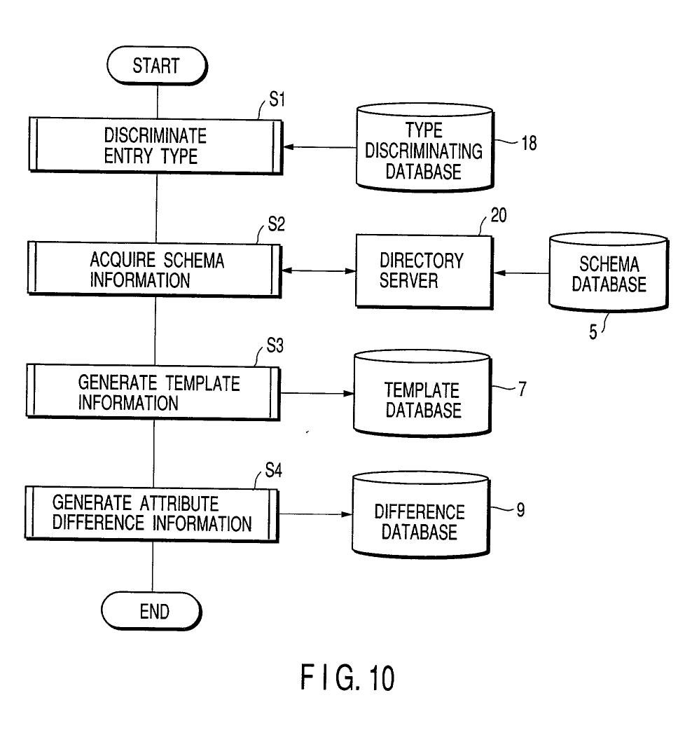

As shown in FIG. 10, in the directory information management apparatus 16 according to the present embodiment, the entry type discriminating section 19 judges an entry type when the entry is newly registered or modified, and acquires an object class of this entry type (step S1).

The schema acquiring section 22 acquires latest schema information, the schema information being managed by the directory server 20, from the schema database 5 by using an LDAP (step S2).

The template generating section 6 generates template information that corresponds to the entry type based on the acquired schema information (step S3). The difference calculating section 8 generates difference information of an attribute that corresponds to the entry type based on the acquired schema information (step S4).

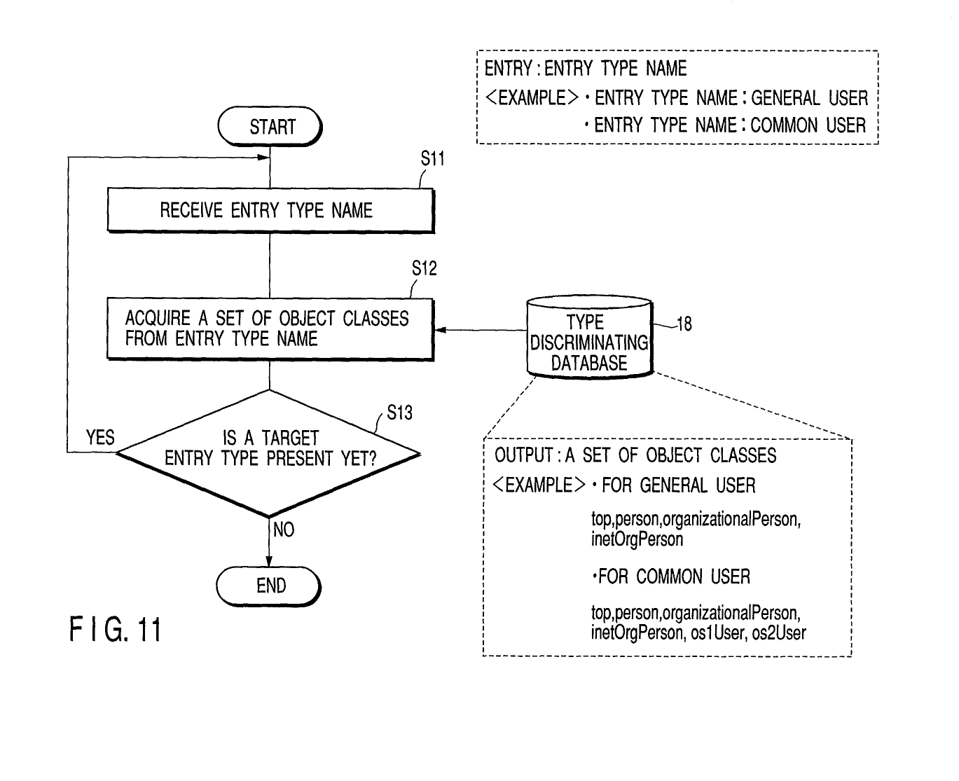

Details of each step of FIG. 10 will be described with reference to FIGS. 11 to 14.

FIG. 11 is a flow chart showing the details of processing (step S1 of FIG. 10) executed by the entry type discriminating section 19 of the directory information management apparatus 16.

Upon the receipt of type name of target entry for addition, modification, and deletion (step S11), the entry type discriminating section 19 refers to the type discriminating database 18 based on the type name of this entry to acquire a set of object classes for this entry type name (step S12). The type discriminating database 18 stores an object class that defines entry type for each entry type.

The entry type discriminating section 19 repeats the above processing if there exists any other target entry type (step S13).

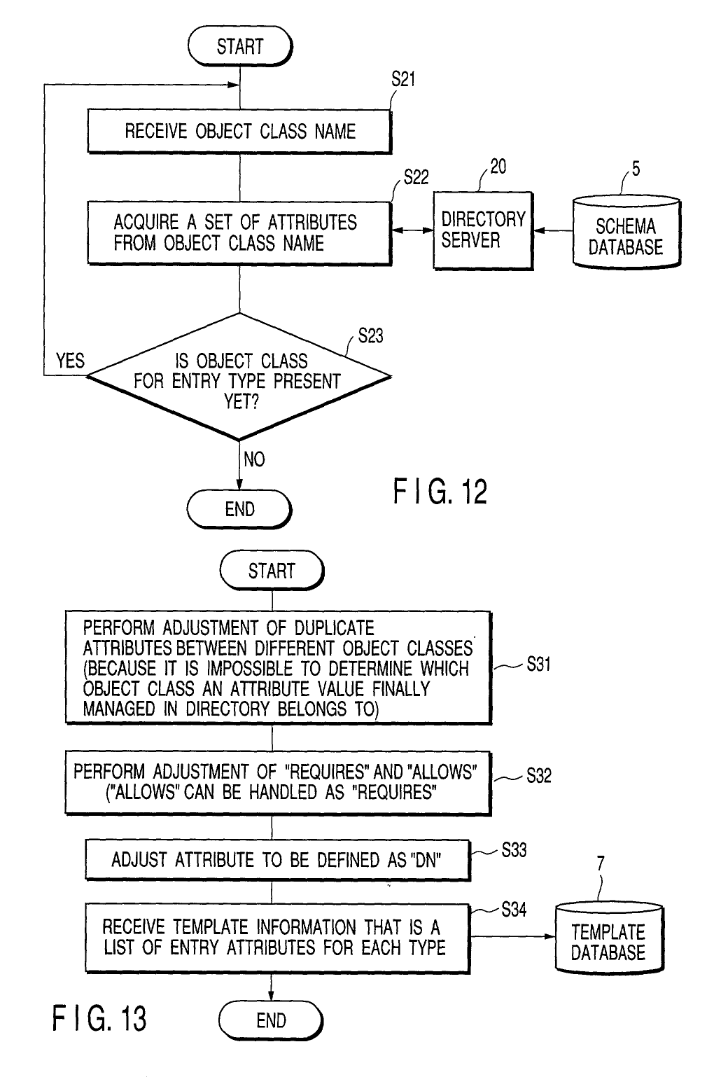

FIG. 12 is a flow chart showing the details of processing (step S2 of FIG. 10) executed by the schema acquiring section 22 of the directory information management apparatus 16.

The schema acquiring section 22 receives a name of an object class acquired by the entry type discriminating section 19 (step S21), and acquires a set of attributes from this object class name by referring to the schema information included in the directory server (step S22).

The schema acquiring section 22 repeats the above processing if there exists any other object class acquired by the entry type discriminating section 19 (step S23).

FIG. 13 is a flow chart showing the details of processing (step S3 of FIG. 10) executed by the template generating section 6 of the directory information management apparatus 16.

The template generating section 6 adjusts duplicate attributes between different object classes from a set of attributes acquired by the schema acquiring section 22 (step S31), and performs adjustment of attributes “requires” and “allows” (step S32). For example, if any of the duplicate attributes is “requires”, it is defined as “requires” after adjustment. If all of the duplicate attributes are “allows”, they are defined as “allows” after adjustment.

The template generating section 6 selects one of the attributes defined as “requires” which can be identified uniquely and determines an attribute to be defined as an entry type “dn” (step S33).

The template generating section 6 generates template information that is a list of attributes for entry management for each entry type from the result of the above processing, and stores the information in the template database 7 (step S34).

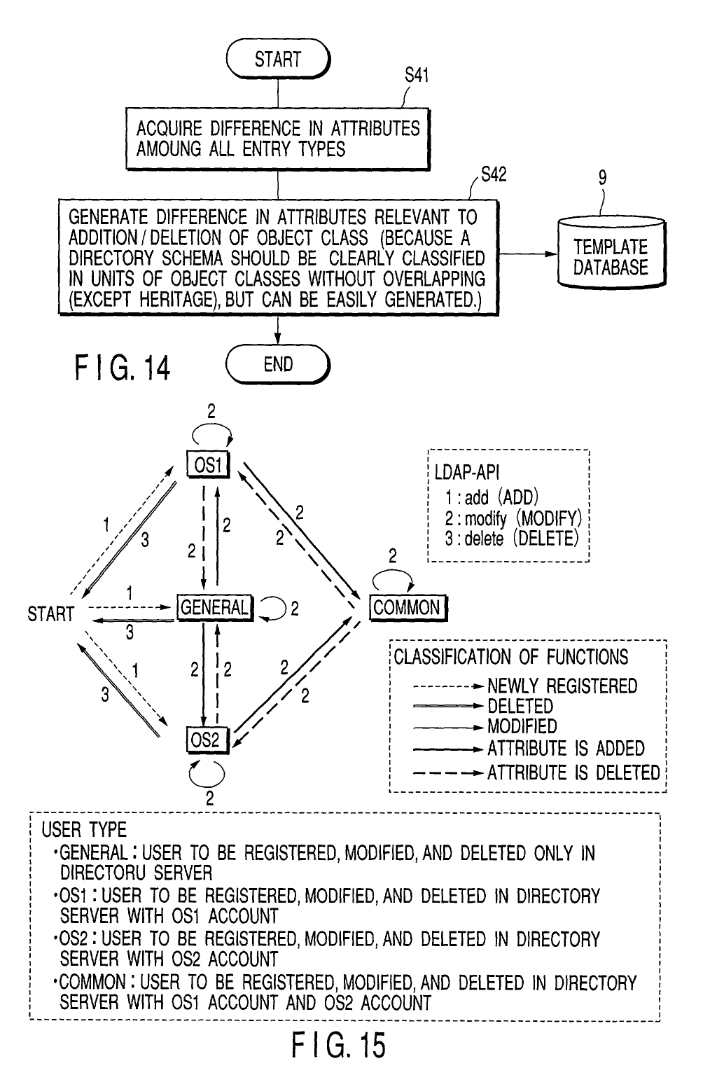

FIG. 14 is a flow chart showing the details of processing (step S4 of FIG. 10) executed by the difference calculating section 8 of the directory information management apparatus 16.

The difference calculating section 8 acquires a difference in attributes among all the entry types based on a set of attributes acquired by the schema acquiring section 5 (step S41).

The difference calculating section 8 stores in the difference database 9 difference in attributes relevant to addition/deletion of an object class as difference information (step S42).

FIG. 15 is a view illustrating an attribute operation state of an entry caused by the directory information management apparatus according to the present embodiment.

An attribute is added or deleted every time the user type changes. In some case, although the user type does not change, an attribute may be modified.

Controlling the directory information management apparatus 16 maintains coincidence between attributes in which there is a possibility that an unmatched attribute occurs between different object classes.

For example, there is a case in which, although user information on a certain user is managed as an OS1 user, there occurs a necessity of handling an account of OS2 for this user, and an attempt is made to change this user type to a common user. In this case, the existing information included in the user information on this user is utilized intact, and only new information required is added as an account of OS2.

On the other hand, there is another case in which, although user information on a certain user is managed as a common user, there is no need to keep an account of OS2, and thus, an attempt is made to delete information concerning OS2 and manage the user type as an OS1 user.

In such a case, the information on the OS1 user is left intact, and only unnecessary information is deleted based on difference information for converting the common user into the OS1 user.

If the user type changes, adjustment of the attributes “requires” and “allows” is performed.

As has been described above, in the directory information management apparatus 16 according to the present embodiment, in the case of managing (adding/modifying/deleting) directory information, template information corresponding to schema information defined in the directory server 20 is utilized. In this manner, an unmatched object class or attribute can be prevented.

In the directory information management apparatus 16 according to the present embodiment, difference information on attributes among entry types is utilized. In this manner, in the case of managing directory information, even if an entry owned attribute is formed of a plurality of object classes, an unmatched object class or attribute among entries can be prevented.

Even if there exists an attribute that belongs to both of an object class targeted to be deleted and an object class not targeted to be deleted, an unmatched object class or attribute among entries can be prevented.

Further, in the directory information management apparatus 16 according to the present embodiment, template information is generated in, for example, an HTML format, whereby such information can be utilized intact for a GUI maintenance tool that operates on the Web. In this manner, there is no need for a person to regenerate an HTML file every time schema information is modified, and a template corresponding to schema information can be automatically generated.

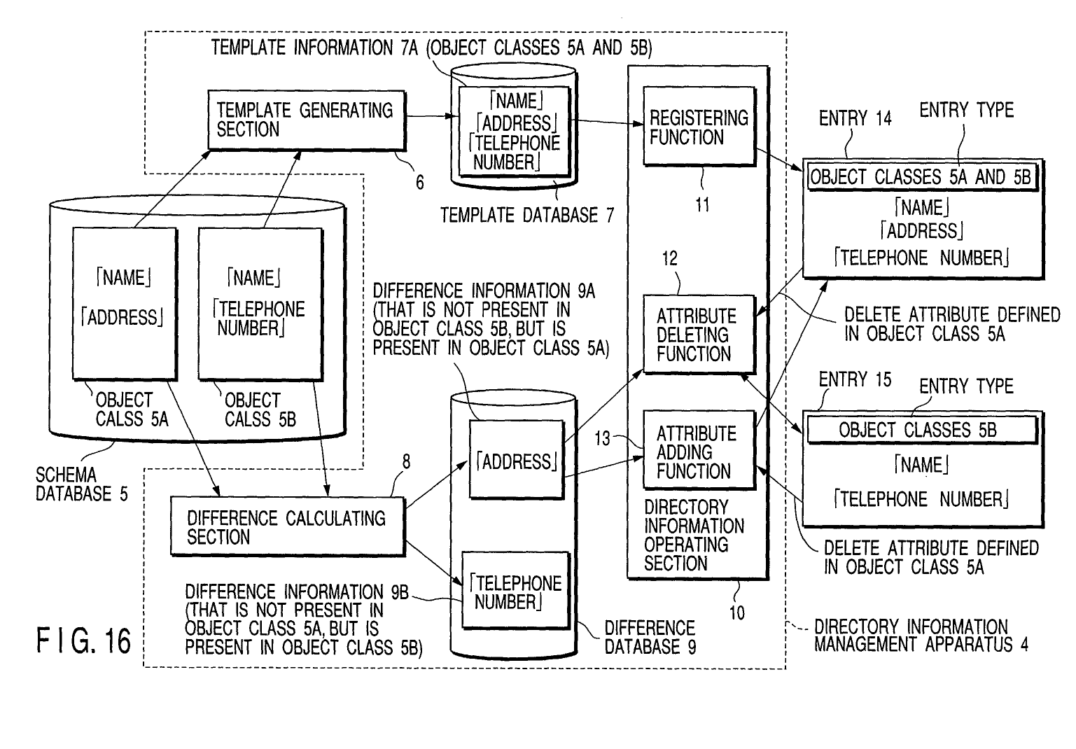

FIG. 16 is a view showing a specific operation of the directory information management apparatus according to the present embodiment. Now, an example of generating a new entry based on object class 5A and object class 5B will be described here.

The schema database 5 stores schema information that is information on the object class 5A and object class 5B and attributes included in these classes. Attributes “name” and “address” belong to the object class 5A, and attributes “name”, and “telephone number” belong to the object class 5B.

The template generating section 6 refers to the schema data stored in the schema database 5. If an entry owned attribute is formed of a plurality of object classes, the template generating section 6 generates template information as information in which duplicate attributes are combined and stores the information in the template database 7. Here, attributes “name”s belonging to the respective object class 5A and object class 5B are combined, and template information 7A on the object class 5A and object class 5B indicative of attributes “name”, “address”, and “telephone number” is generated.

The difference calculating section 8 obtains difference information indicative of an attribute that is included in one entry type, but is not included in the other entry type between entry types, each of which is formed of at least one object class, and stores the information in the difference database 9 by referring to the schema information included in the schema database 5. This database 5 stores difference information 9A for comparing object class 5A and object class 5B with each other, the difference information being indicative of an attribute “address” owned by only the object class 5A, not an attribute owned by the object class 5B. There is no attribute owned by the object class 5A, and difference information 9B indicative of an attribute “telephone number” owned by only the object class 5B is stored.

The directory information operating section 10 essentially comprises the registering function 11, attribute deleting function 12, and attribute adding function 13.

During entry registration, the registering function 11 generates an entry 14 that contains information on an attribute indicated by the corresponding template information 7A, and registers the entry in the directory server 20 by referring to the template database 7.

In the case where an attribute defined in the object class 5A is deleted from the entry 14, the attribute deleting function 12 registers in the directory server 20 an entry 15 having deleted therefrom information on an attribute “address” that is included before deletion, but is not included after deletion by referring to the difference information 9A included in the difference database 9.

If an attribute defined in the object class 5A is added to the entry 15, the attribute adding function 13 registers in the directory server 20 the entry 14 having added thereto information on an attribute “address” that is not included before addition, but is included after addition by referring to the difference information 9A included in the difference database 9.

By utilizing the directory information management apparatus according to the present embodiment as described above, an entry is generated in accordance with template information in which duplicate attributes are combined. Thus, coincidence of entries, each of which is formed of a plurality of object classes, can be ensured, and the user can operate an entry without discussing schema information in detail. Even if an entry attribute is added or deleted by addition and deletion of an object class, information is deleted and added in accordance with the difference information. Thus, deletion of a necessary attribute and addition of an unnecessary attribute can be prevented. Therefore, a directory service can be improved.

Although the present embodiment describes an example when the schema database 5 or the directory database 21 is not included in the directory information management apparatus, the schema database 5 or directory database 21 may be included in the directory information management apparatus.

Although the present embodiment describes an example when the entry type is formed of one or two object classes, such entry type may be formed of three or more object classes. In this case, the template information corresponding to each entry type is obtained as information concerning an attribute free of duplication together with each object class owned attribute, and difference information is obtained as information concerning an attribute that is included in one object class, but is not included in the other object class between object classes.

As has been described above, according to a first aspect of the present invention, there is provided a directory information management apparatus, wherein the type of entry registered in a tree structured database is formed of at least one object class having at least one attribute, and such an entry is managed by employing an attribute owned by such an entry. According to the first aspect of the present invention, the directory information management apparatus may comprise a template generating section which generates template information in which duplicate attributes of the attributes belonging to a plurality of object classes are combined, thereby eliminating duplication, relevant to the entry type formed of the plurality of object class. The template generating section may generate template information in an HTML (HyperText Makeup Language) format, wherein such template information can be utilized intact for a GUI maintenance tool that operates on the Web.

According to the first aspect of the present invention, attributes free of duplication can be recognized for each entry type. Therefore, it is possible to ensure coincidence between object classes or attributes, and an entry can be properly handled in a directory service.

According to a second aspect of the present invention, there is provided a directory information management apparatus comprising a registering section which reads template information in which duplication is eliminated by combining duplicate attributes belonging to a plurality of object classes, and registers attributes indicated by template information in an entry of the entry type formed of the plurality of object classes.

According to the second aspect of the present invention, an entry can be registered based on template information while an attribute duplication is eliminated. Therefore, the coincidence of object classes or attributes can be ensured, and an entry can be properly handled in a directory service. A registered entry may be deleted or modified based on template information.

According to a third aspect of the present invention, there is provided a directory information management apparatus, wherein an entry registered in a tree structured database has at least one attribute according to entry type, and such an entry is managed by employing its entry owned attribute. The directory information management apparatus according to the third aspect of the present invention comprises a difference generating section generates difference information indicative of an attribute that belongs to a first entry type, but does not belong to a second entry type.

If an object class or an attribute is deleted from an entry by employing this difference information, it is possible to recognize which attribute should be deleted. Therefore, a necessary attribute can be prevented from being deleted, the coincidence of object classes or attributes can be ensured, and an entry can be properly handled in a directory service.

According to a fourth aspect of the present invention, there is provided a directory information management apparatus, comprising an attribute deleting section which, if an entry of a second entry type comprising an attribute that belongs to a first entry type is modified to an entry of the first entry type, reads difference information indicative of an attribute that belongs to a second entry type, but does not belong to the first entry type, and deletes an attribute indicated by the difference information from this entry.

If an object class or an attribute is deleted from an entry by employing this difference information, it is possible to recognize which attribute should be deleted. Therefore, a necessary attribute can be prevented from being deleted, the coincidence of object classes or attributes can be ensured, and an entry can be properly handled in a directory service.

According to a fifth embodiment of the present invention, there is provided a directory information management apparatus comprising an attribute adding section which, if an entry of a first entry type is modified to an entry of a second entry type including an attribute that belongs to the first entry type, reads difference information indicative of an attribute that belongs to the second entry type, but does not belong to the first entry type, and adds an attribute indicative of the difference information to this entry.

According to the fifth aspect of the present invention, if there is a need to add an attribute to an entry, only an attribute that is not included in the entry is added. Therefore, even if an attribute is added to an entry, attributes can be prevented from being duplicated, the coincidence of object classes or attributes for setting (defining) an entry can be ensured, and an entry can be properly handled in a directory service.

According to a sixth embodiment of the present invention, there is provided a directory information management apparatus comprising a type discrimination database which stores the type of object class that configures an entry type for each entry type, an entry type discriminating section which acquires an object class that configures an entry type by referring to the type discrimination database, a schema acquiring section which acquires schema information defined in a schema database, a template generating section which generates template information in which a duplication is eliminated by combining duplicated attributes of attributes that belong to a plurality of object classes relevant to the entry type formed of a plurality of object classes based on an object class acquired by the entry type discriminating section and schema information acquired by the schema acquiring section, a template database which stores template information generated by the template generating section, a difference generating section which generates difference information indicative of a difference in attributes between entry types based on the object class acquired by the entry type discriminating section and the schema information acquired by the schema acquiring section, and a difference database which stores difference information generated by the difference generating section.

According to the sixth aspect of the present invention, the template information and the difference information are obtained and stored. By using the template information and the difference information, attributes free of duplication can be recognized for each entry type. It is possible to ensure coincidence between object classes or attributes. If an object class or an attribute is deleted from an entry by employing this difference information, it is possible to recognize which attribute should be deleted. Therefore, a necessary attribute can be prevented from being deleted, the coincidence of object classes or attributes can be ensured, and an entry can be properly handled in a directory service.

According to a seventh aspect of the present invention, there is provided a directory information management apparatus comprising a template database which stores template information in which a duplication is eliminated by combining duplicate attributes of attributes that belong to a plurality of object classes relevant to the entry type formed of a plurality of object classes, a difference information database which stores difference information indicative of a difference in attributes between entry types, an operation processing section which registers an entry in a database based on the template information stored in the template database, an attribute adding section which, if an entry type of an entry is modified, and then, an attribute is added, adds an attribute to an entry based on the difference information stored in the difference information database, and an attribute deleting section which, if an entry type of an entry is modified, and then, an attribute is deleted, deletes an attribute of an entry based on the difference information stored in the difference deleting section.

Therefore, the coincidence of object classes or attributes for setting an entry can be ensure, and an entry can be properly handled in a directory service.

The above functions can be implemented by a software.

The directory information management apparatus described above may be applied as a program that can be executed by a computer by writing them into a recording medium such as a magnetic disk (such as a floppy disk or a hard disk), an optical disk (such as CD-ROM or DVD), or a semiconductor memory. In addition, this program can be transmitted by means of a communications medium, and can be applied to a computer or a computer system.

Additional advantages and modifications will readily occur to those skilled in the art. Therefore, the present invention in its broader aspects is not limited to the specific details, representative devices, and illustrated examples shown and described herein. Accordingly, various modifications may be made without departing from the spirit or scope of the general inventive concept as defined by the appended claims and their equivalents.

As has been described above in detail, according to the present invention, an attribute duplication is eliminated in management of directory information, and thus, an unmatched object class or attribute can be prevented. If an attribute defined from any of the object classes is deleted from an entry that contains an attribute defined from a plurality of object classes, only an attribute that belongs to the object class targeted to be deleted, and does not belong to another object class targeted to be deleted is deleted. Therefore, an unmatched object class or attribute can be prevented among entries.

What is claimed is:

1. A directory information management apparatus using a tree structured database wherein entries are registered in a tree shape, the entry comprising at least one attribute, the directory information management apparatus comprising:
a schema database which stores object classes for entry types, the object class comprising at least one attribute;
a template generating section which, when a new entry type is created from object classes, reads object classes in accordance with an entry type from said schema database, combines duplicate attributes belonging to the object classes, and generates template information indicating attributes included in the entry.

2. The directory information management apparatus according to claim 1, wherein
said object class comprises a mandatory attribute which must be included in the entry and an optional attribute which may not be included in the entry; and
said template generating section combines the duplicate attributes as a mandatory attribute if one of the duplicate attributes is the mandatory attribute and as an optional attribute if all of the duplicate attributes are the optional attributes.

3. The directory information management apparatus according to claim 1, further comprising:
a registering section which reads the template from said template database and registers the new entry comprising a value of attribute included in the read template.

4. A directory information management apparatus using a tree structured database wherein entries are registered in a tree shape, the entry comprising at least one attribute, the directory information management apparatus comprising:
a schema database which stores object classes for entry types, the object class comprising at least one attribute;
a difference generating section which generates difference information of attribute that belongs to two object classes stored in the schema database; and
a difference database which stores the difference information generated by said difference generating section.

5. The directory information management apparatus according to claim 4, further comprising:
an attribute deleting section which, when an entry of a second entry type comprising an attribute that belongs to a first entry type is modified to an entry of the first entry type, reads difference information indicative of an attribute that belongs to the second entry type, but does not belong to the first entry type from said difference database, and deletes an attribute indicated by the read difference information from the entry of the second entry type.

6. The directory information management apparatus according to claim 4, further comprising:
an attribute adding section which, when an entry of a first entry type is modified to an entry of a second entry type comprising an attribute that belongs to the first entry type, reads difference information indicative of an attribute that belongs to the second entry type, but does not belong to the first entry type from said difference database, and adds an attribute indicated by the read difference information to the entry of the first entry type.

7. A directory information management apparatus using a tree structured database wherein entries are registered in a tree shape, the entry comprising at least one attribute, the directory information management apparatus comprising:
a schema database which stores object classes for entry types, the object class comprising at least one attribute;
a template generating section which, when a new entry type is created from object classes, reads object classes in accordance with an entry type from said schema database, combines duplicate attributes belonging to the object classes, and generates template information indicating attributes included in the entry;
a difference generating section which generates difference information of attribute that belongs to two object classes stored in the schema database; and
a difference database which stores the difference information generated by said difference generating section.

8. The directory information management apparatus according to claim 7, further comprising:
a registering section which reads the template from said template database and registers the new entry comprising a value of attribute included in the read template;
an attribute deleting section which, when an entry of a second entry type comprising an attribute that belongs to a first entry type is modified to an entry of the first entry type, reads difference information indicative of an attribute that belongs to a second entry type, but does not belong to the first entry type from said difference database, and deletes an attribute indicated by the read difference information from the entry of the second entry type; and
an attribute adding section which, when an entry of a first entry type is modified to an entry of a second entry type comprising an attribute that belongs to the first entry type, reads difference information indicative of an attribute that belongs to the second entry type, but does not belong to the first entry type from said difference database, and adds an attribute indicated by the read difference information to the entry of the first entry type.

9. A directory information management method using a tree structured database wherein entries are registered in a tree shape, the entry comprising at least one attribute, the directory information management method comprising:
reading, when a new entry type is created from object classes, object classes in accordance with an entry type from a schema database which stores object classes for entry types, the object class comprising at least one attribute;
combining duplicate attributes belonging to the object classes and generating template information indicating attributes included in the entry; and
reading the template from said template database and registering the new entry comprising a value of attribute included in the read template.

10. A directory information management method using a tree structured database wherein entries are registered in a tree shape, the entry comprising at least one attribute, the directory information management method comprising:
generating difference information of attribute that belongs to two object classes stored in a schema database which stores object classes for entry types, the object class comprising at least one attribute, and storing the difference information in a difference database; and
reading, when an entry of a second entry type comprising an attribute that belongs to a first entry type is modified to an entry of the first entry type, difference information indicative of an attribute that belongs to the second entry type, but does not belong to the first entry type from said difference database, and deleting an attribute indicated by the read difference information from the entry of the second entry type.

11. A directory information management method using a tree structured database wherein entries are registered in a tree shape, the entry comprising at least one attribute, the directory information management method comprising:
generating difference information of attribute that belongs to two object classes stored in a schema database which stores object classes for entry types, the object class comprising at least one attribute, and storing the difference information in a difference database;
reading, when an entry of a first entry type is modified to an entry of a second entry type comprising an attribute that belongs to the first entry type, difference information indicative of an attribute that belongs to the second entry type, but does not belong to the first entry type from said difference database, and adding an attribute indicated by the read difference information to the entry of the first entry type.

12. An article of manufacture comprising a computer usable medium having computer readable program for a directory information management apparatus using a tree structured database wherein entries are registered in a tree shape, the entry comprising at least one attribute, the computer readable program comprising:
computer readable program code means for causing a computer to store object classes for entry types to a schema database, the object class comprising at least one attribute; and
computer readable program code means for causing a computer to read, when a new entry type is created from object classes, object classes in accordance with an entry type from said schema database, combine duplicate attributes belonging to the object classes, and generate template information indicating attributes included in the entry.

13. The article of manufacture according to claim 12, wherein
said object class comprises a mandatory attribute which must be included in the entry and an optional attribute which may not be included in the entry; and
the duplicate attributes are combined as a mandatory attribute if one of the duplicate attributes is the mandatory attribute and as an optional attribute if all of the duplicate attributes are the optional attributes.

14. The article of manufacture according to claim 12, further comprising:
computer readable program code means for causing a computer to read the template from said template database and register the new entry comprising a value of attribute included in the read template.

15. An article of manufacture comprising a computer usable medium having computer readable program for a directory information management apparatus using a tree structured database wherein entries are registered in a tree shape, the entry comprising at least one attribute, the computer readable program comprising:
computer readable program code means for causing a computer to store object classes for entry types to a schema database, the object class comprising at least one attribute;
computer readable program code means for causing a computer to generate difference information of attribute that belongs to two object classes stored in the schema database; and
computer readable program code means for causing a computer to stores the generated difference information.

16. The article of manufacture according to claim 15, further comprising:
computer readable program code means for causing a computer to read, when an entry of a second entry type comprising an attribute that belongs to a first entry type is modified to an entry of the first entry type, difference information indicative of an attribute that belongs to the second entry type, but does not belong to the first entry type from said difference database, and delete an attribute indicated by the read difference information from the entry of the second entry type.

17. The article of manufacture according to claim 15, further comprising:
computer readable program code means for causing a computer to read, when an entry of a first entry type is modified to an entry of a second entry type comprising an attribute that belongs to the first entry type, difference information indicative of an attribute that belongs to the second entry type, but does not belong to the first entry type from said difference database, and add an attribute indicated by the read difference information to the entry of the first entry type.

18. An article of manufacture comprising a computer usable medium having computer readable program for a directory information management apparatus using a tree structured database wherein entries are registered in a tree shape, the entry comprising at least one attribute, the computer readable program comprising:
computer readable program code means for causing a computer to store object classes for entry types to a schema database, the object class comprising at least one attribute;
computer readable program code means for causing a computer to read, when a new entry type is created from object classes, object classes in accordance with an entry type from said schema database, combine duplicate attributes belonging to the object classes, and generate template information indicating attributes included in the entry;
computer readable program code means for causing a computer to generate difference information of attribute that belongs to two object classes stored in the schema database; and
computer readable program code means for causing a computer to store the generated difference information.

19. The article of manufacture according to claim 18, further comprising:
computer readable program code means for causing a computer to read the template from said template database and register the new entry comprising a value of attribute included in the read template;
computer readable program code means for causing a computer to read, when an entry of a second entry type comprising an attribute that belongs to a first entry type is modified to an entry of the first entry type, difference information indicative of an attribute that belongs to a second entry type, but does not belong to the first entry type from said difference database, and delete an attribute indicated by the read difference information from the entry of the second entry type; and
computer readable program code means for causing a computer to read, when an entry of a first entry type is modified to an entry of a second entry type comprising an attribute that belongs to the first entry type, difference information indicative of an attribute that belongs to the second entry type, but does not belong to the first entry type from said difference database, and add an attribute indicated by the read difference information to the entry of the first entry type.
